(19) United States
(12) Patent Application Publication
(10) Pub. No.: US 2026/0329319 A1
(43) Pub. Date: Oct. 22, 2026

(54) LOW DROPOUT REGULATOR WITH POLE-ZERO COMPENSATION AND OPERATING METHOD THEREOF

(71) Applicant: PIXART IMAGING INC., Hsin-Chu County (TW)

(72) Inventors: Hsin-Kai CHENG, Hsin-Chu County (TW); Ren-Chieh LIU, Hsin-Chu County (TW)

(21) Appl. No.: 19/185,266

(22) Filed: Apr. 22, 2025

(51) Int. Cl. G05F 1/575

(52) U.S. Cl. CPC G05F 1/575

(57) ABSTRACT

There is provided a LDO regulator including a compensation capacitor, a first compensation resistor, a second compensation resistor and a switching device. The switching device is used to bypass/short the first compensation resistor. When the switching device is not conducted, the compensation capacitor, the first compensation resistor and the second compensation resistor determine a first zero. When the switching device is conducted, the compensation capacitor and the second compensation resistor determine a second zero. A frequency of the second zero is higher than that of the first zero.

### FIELD OF THE DISCLOSURE

This disclosure generally relates to a low dropout (LDO) regulator and, more particularly, to an LDO regulator that moves a zero toward a high frequency direction when a load current of the LDO regulator is larger than a predetermined value to cause the zero to compensate an output pole to stabilize the LDO regulator circuit, and an operating method of the LDO regulator.

### BACKGROUND OF THE DISCLOSURE

Please refer to FIG. 1, it is a schematic diagram of a transfer function of a conventional LDO regulator. The traditional LDO regulator generally has two poles P1 and P2 as well as one zero Z1, wherein the zero Z1 does not likely change with a load current of the LDO regulator that causes the transfer function to have multiple transitions in the high frequency zone thereby causing the LDO regulator unstable.

In addition, when the load current is too large, the output pole P1 moves toward a high frequency direction such that the zero Z1 is not able to compensate the output pole P2 that may cause the LDO regulator to have insufficient stability, especially in the case that the gain bandwidth (BGW) is large.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides an LDO regulator that moves a zero toward a high frequency direction when a load current of the LDO regulator exceeds a predetermined value among a predetermined load current range to cause the zero to be able to compensate an output pole to stabilize the LDO regulator circuit, and an operating method of the LDO regulator.

The present disclosure further provides an LDO regulator that detects a load current to accordingly conduct a control switch to change a frequency of the zero, and an operating method of the LDO regulator.

The present disclosure provides a low dropout (LDO) regulator including an error amplifier, a first transistor, a compensation capacitor and a compensation resistor. The error amplifier has an inverting input terminal, a noninverting input terminal and an output terminal. The first transistor is coupled between an input voltage and a first node, and a gate of the first transistor is coupled to the output terminal of the error amplifier. The compensation resistor and the compensation capacitor are connected in series between the output terminal of the error amplifier and the first node, wherein the compensation resistor is configured to be switched to at least two resistance.

The present disclosure further provides an LDO regulator including a compensation capacitor, a first compensation resistor, a second compensation resistor and a switching device. The second compensation resistor, the first compensation resistor and the compensation capacitor are connected in series. The switching device is configured to bypass the first compensation resistor. The compensation capacitor, the first compensation resistor and the second compensation resistor are configured to determine a first zero. The compensation capacitor and the second compensation resistor are configured to determine a second zero. The switching device is configured to bypass the first compensation resistor upon a load current of the LDO regulator being larger than a predetermined current value.

The present disclosure further provides an operating method of an LDO regulator, which includes a zero control circuit, a current detection circuit and a buffer connected between the zero control circuit and the current detection circuit. The operating method includes the steps of: detecting, by the current detection circuit, a load current of the LDO regulator; outputting, by the buffer, a control signal upon the detected load current being larger than a predetermined current value; and moving a frequency of a zero toward a high frequency direction after the zero control circuit receives the control signal.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic diagram of a transfer function of a conventional LDO regulator.

FIG. 2 is a circuit diagram of an LDO regulator according to one embodiment of the present disclosure.

FIG. 3 is a schematic diagram of a transfer function after a switching device of an LDO regulator of the present disclosure is conducted.

FIG. 4 is a circuit diagram of generating a current source of an LDO regulator according to one embodiment of the present disclosure.

FIG. 5 is a flow chart of an operating method of an LDO regulator according to one embodiment of the present disclosure.

FIG. 6 is a circuit diagram of an LDO regulator according to another embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a low dropout (LDO) regulator that moves a zero toward a high frequency direction to compensate an output pole under a heavy-load, and an operating method of the LDO regulator. The present disclosure uses a current detection circuit to detect a load current of the LDO regulator and uses a digital signal outputted by a buffer to control a zero control circuit to change a frequency of the zero when the load current is larger than a predetermined current value.

In one aspect, the LDO regulator of the present disclosure has a predetermined load current range, which is determined according to a load connected downstream. When a present load current is larger than a predetermined current value within the predetermined load current range, a frequency of the zero is moved toward a frequency of an output pole to compensate the output pole thereby stabilizing the LDO regulator circuit.

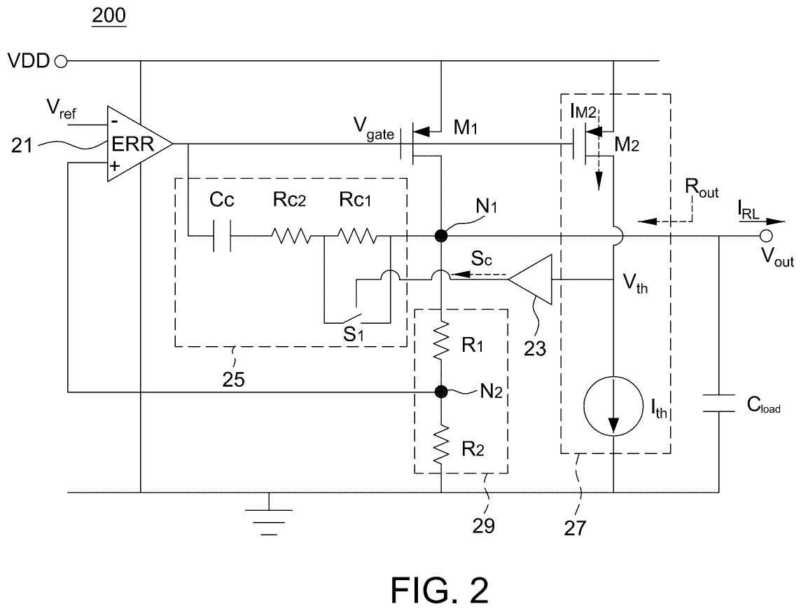

Please refer to FIG. 2, it is a circuit diagram of an LDO regulator 200 according to one embodiment of the present disclosure. The LDO regulator 200 includes an error amplifier 21, a buffer 23, a zero control circuit 25, a current detection circuit 27, a voltage divider 29, an output capacitor Cload and a pass transistor (or called first transistor) M1.

In one aspect, the buffer 23 is formed by cascading two inverters together, but not limited thereto. The buffer 23 may be other circuits that output a digital signal (e.g., “1” or “0”) according to an input voltage or an input current thereof to control ON/OFF of a switching device. In FIG. 2, the buffer 23 is shown to be connected between the zero control circuit 25 and the current detection circuit 27 to receive an input voltage Vth.

The error amplifier 21 has an inverting input terminal (shown as “−”), a noninverting input terminal (shown as “+”) and an output terminal. The inverting input terminal is coupled to a reference voltage Vref.

The pass transistor M1 is coupled between an input voltage VDD and a first node N1. A gate of the pass transistor M1 is coupled to the output terminal of the error amplifier 21.

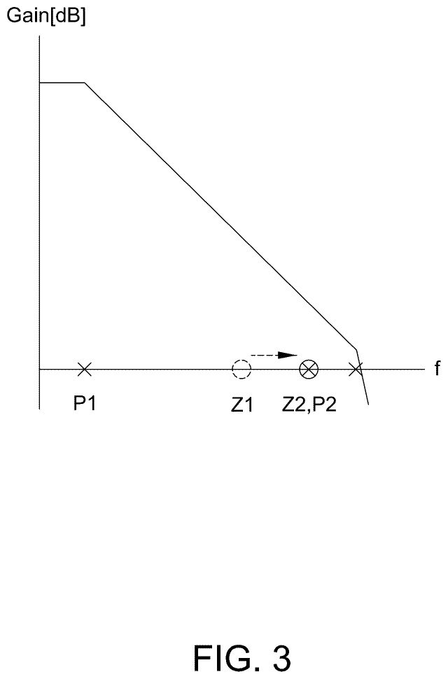

An output capacitor Cload is coupled between the first node N1 and ground. The output capacitor Cload and an equivalent output resistor Rout of the LDO regulator 200 determine an output pole P2, e.g. referring to FIG. 3. For example, a frequency of the output pole P2 fp2≈1/(2π×Rout×Cload). The method of calculating the equivalent output resistor Rout is known to the art and not a main objective of the present disclosure, and thus details thereof are not described herein.

The zero control circuit 25 includes a compensation capacitor Cc, a first compensation resistor Rc1 and a second compensation resistor Rc2 coupled between the output terminal of the error amplifier 21 and the first node N1 in series. Resistance of the first compensation resistor Rc1 and a second compensation resistor Rc2 are determined using an equation R=(Cload+Cc)/(gm1×Cc), wherein gm1 is transconductance of the pass transistor M1.

In the present disclosure, in order to move the zero Z1 toward a high frequency direction, the second compensation resistor Rc2 is arranged to be much smaller than the first compensation resistor Rc1, e.g., by 17 to 23 times, to increase an adjustment rage of the zero Z1. Please refer to FIG. 3, it is a schematic diagram of a transfer function after the switching device S1 of the LDO regulator 200 of the present disclosure is conducted. In the present disclosure, the compensation capacitor Cc, the first compensation resistor Rc1 and the second compensation resistor Rc2 determine a first zero, e.g., referring to Z1 shown in FIG. 3 (e.g., a first frequency of Z1 f_{Z1}≈1/2π×(Rc1+Rc2)×Cc); the compensation capacitor Cc and the second compensation resistor Rc2 determine a second zero, e.g., referring to Z2 shown in FIG. 3 (e.g., a second frequency of Z2 f_{Z2}≈1/2π×Rc2×Cc). As mentioned above, preferably the second compensation resistor Rc2 is much smaller than the first compensation resistor Rc1, and thus Rc1+Rc2 is very close to Rc1. Therefore, adding the second compensation resistor Rc2 does not significantly change a frequency position of zero f_{Z}≈1/2π×Rc1×Cc formed only by the first compensation resistor Rc1 and the compensation capacitor Cc, i.e. f_{Z}≈f_{Z1}. It is seen from FIG. 3 that the second frequency of the second zero Z2 is higher than the first frequency of the first zero Z1.

The zero control circuit 25 further includes a switching device S1 shown to be connected in parallel with the first compensation resistor Rc1, but not limited thereto. The connection of the switching device S1 is determined according to a type thereof. In the present disclosure, the switching device S1 is used to bypass the first compensation resistor Rc1 according to a control signal Sc, i.e. the first compensation resistor Rc1 is shorted by the switching device S1. In one aspect, the buffer 23 is sued to output the control signal Sc, e.g., a digital value “1”, but not limited to. In the present disclosure, resistance of the second compensation resistor Rc2 is selected in the way that when the control signal Sc conducts the switching device S1 to bypass the first compensation resistor Rc1, a second frequency of the second zero Z2 is equal to a frequency of the output pole P2 so as to compensate the output pole P2 and stabilize the LDO regulator circuit. Preferably, all corners of the LDO regulator 200 cause the LDO phase to be larger than 60 degrees.

The current detection circuit 27 includes a second transistor M2 and a current source Ith. The second transistor M2 is coupled between the input voltage VDD and the first node N1. A gate of the second transistor M2 is coupled to the gate of the pass transistor M1. In one aspect, a size of the second transistor M2 is smaller than that of the pass transistor M1 by more than 100 times. For example, if a size of M1=1, a size of M2 is larger than or equal to 100.

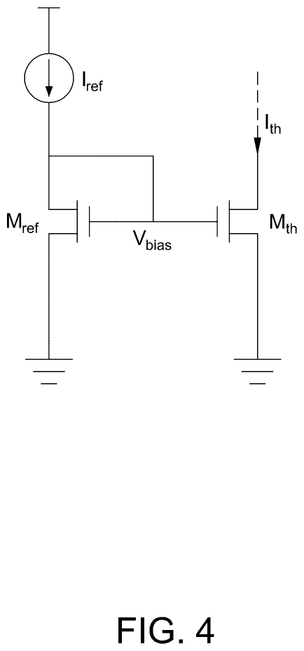

The current source Ith is coupled between a drain of the second transistor M2 and the ground. The buffer 23 is coupled between the switching device S1 and the drain of the second transistor M2. FIG. 4 shows a circuit diagram to generate the current source Ith of the LDO regulator 200 of the present disclosure, including a current mirror to generate a bias voltage Vbias using a reference current Iref, and the current source Ith is generated by arranging a ratio of the transistors Mref and Mth. It should be mentioned that FIG. 4 is only intended to show one aspect of generating the current source Ith. The current source Ith may be generated by other known circuits and is not limited to that shown in the present disclosure.

In the present disclosure, when a load is connected downstream of the LDO regulator 200, a regulated DC output voltage Vout provides to the load and generates a load current I_{RL}. Preferably, the LDO regulator 200 has a predetermined load current range, e.g., 0 to 10 mA, but not limited thereto. When a present load current I_{RL} is larger than a predetermined current value, e.g., 5 mA to 7 mA, within the predetermined load current range, the buffer 23 outputs the control signal Sc to short the first compensation resistor Rc1 to move zero Z1 toward higher frequency as compensation.

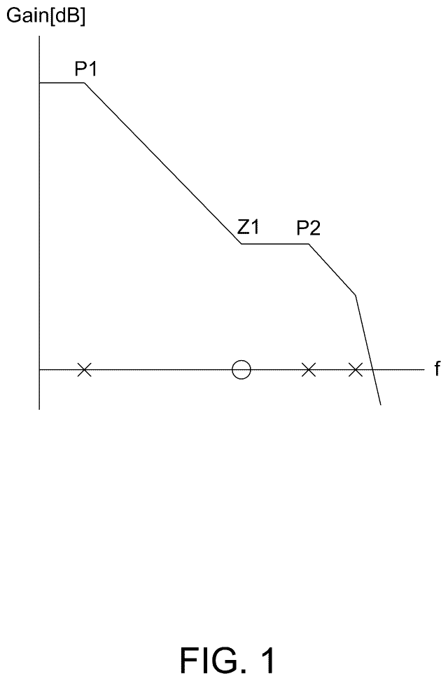

It is assumed that when the present load current I_{RL} is smaller than the predetermined current value, the zero Z1 and the output pole P2 are shown in FIG. 1. When the present load current I_{RL} gradually increases, a gate voltage Vgate of the pass transistor M1 and the second transistor M2 gradually decreases to cause a current I_{M2} of the second transistor M2 to increase. When the current I_{M2} is larger than Ith, an input voltage Vth of the buffer 23 is increased with the increase of the present load current I_{RL}. When the voltage Vth exceeds a threshold voltage of the buffer (i.e. present load current I_{RL} being larger than the predetermined current value), the buffer 23 outputs the control signal Sc to conduct the switching device S1 to bypass the first compensation resistor Rc1. Meanwhile, the compensation capacitor Cc and the second compensation resistor Rc2 determine a second zero Z2, referring to FIG. 3.

It should be mentioned that two zeros Z1 and Z2 shown in FIG. 3 respectively indicate a zero before and after the switching device S1 is conducted, and the two zeros Z1 and Z2 are not to indicate two simultaneously coexist zeros of the LDO regulator 200. That is, Z2 is shifted from Z1 after the switching device S1 is conducted.

The voltage divider 29 includes a first voltage divider resistor R1 and a second voltage divider resistor R2. The first voltage divider resistor R1 is connected between the first node N1 and a second node N2. The second voltage divider resistor R2 is connected between the second node N2 and the ground. The second node N2 is coupled to the noninverting input terminal of the error amplifier 21. The function of the voltage divider 29 in an LDO regulator is known to the art and is not a main objective of the present disclosure, and thus details thereof are not described herein.

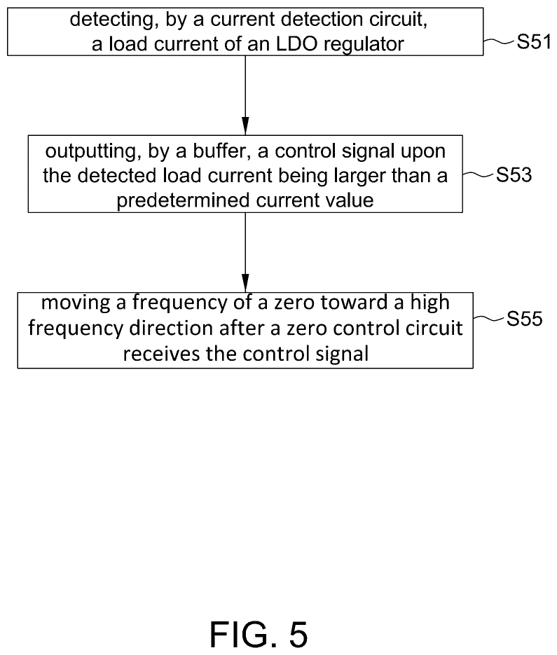

Please refer to FIG. 5, it is a flow chart of an operating method of the LDO regulator 200 according to one embodiment of the present disclosure, including the steps below.

Step S51: The current detection circuit 27 detects a load current I_{RL} of the LDO regulator 200. As mentioned above, when the load current I_{RL} increases, the input voltage Vth of the buffer 23 increases when I_{M2}>Ith.

Step S53: When the load current I_{RL} is larger than a predetermined current value (i.e. the input voltage Vth larger than a threshold voltage of the buffer 23), the buffer 23 outputs a control signal Sc, e.g., a digital value “1” or “0” according to types of the buffer 23 and the switching device S1.

Step S55: After receiving the control signal Sc, the zero control circuit 25 moves a frequency of the zero toward a high frequency direction, referring to FIG. 3. As mentioned above, the control signal Sc outputted by the buffer 23 is used to conduct the switching device S1 to bypass the first compensation resistor Rc1 to cause the zero Z1 to move toward the high frequency direction. Preferably, by properly arranging the second compensation resistor Rc2, the frequency of the zero Z1 is moved to the same position as the frequency of the pole P2, e.g., FIG. 3 showing Z2 and P2 at a substantially identical frequency.

In the present disclosure, the pass transistor M1 and the second transistor M2 are described by PMOS transistors as an example.

It should be mentioned that values mentioned in the present disclosure, e.g., including the predetermined load current range, the predetermined current value, the size ratio of transistors, are only intended to illustrate but not to limit the present disclosure.

It should be mentioned that although the above embodiment is described in the way that the zero control circuit 25 includes two compensation resistors Rc1 and Rc2 as an example, the present disclosure is not limited thereto. In another aspect, the zero control circuit 25 may include more than two compensation resistors respectively controlled by different switching devices, e.g., using multiple buffers respectively having different threshold voltages to control the multiple switching devices in order to move the zero toward a high frequency direction. In a further aspect, the compensation resistors Rc1 and Rc2 are replaced by a variable transistor(s) with the resistance reduced with increment of a load current I_{RL} in order to move the zero toward a high frequency direction. The variable transistor has at least two selectable resistance, e.g., one is equal to Rc1+Rc2 and the other one is equal to Rc2, but not limited thereto.

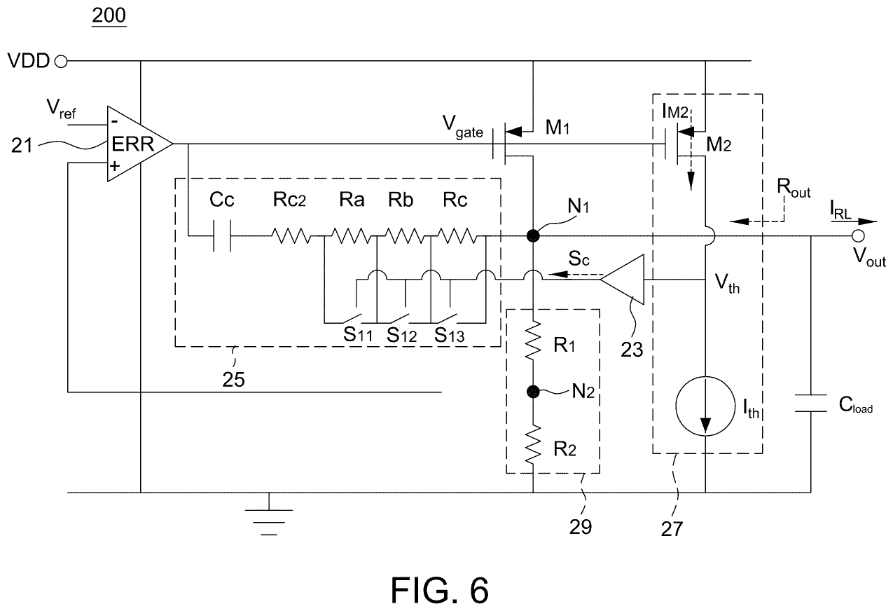

In another aspect, Rc1 is a variable resistor having multiple step variable resistance or stepless variable resistance, the switch device S1 is a multiple step switch or a stepless switch, and the buffer 23 provides multiple step digital signals or stepless digital signal (i.e. Sc) to change an equivalent resistance of the zero control circuit 25, e.g., referring to FIG. 6 in which conduction of the switch devices S₁₁, S₁₂ and S₁₃ are determined according to the control signal Sc from the buffer 23. By conducting different combinations of the switch devices S₁₁, S₁₂ and S₁₃, it is able to change the equivalent resistor, e.g., Ra, Rb, Rc, Ra+Rb, Rb+Rc, Ra+Rc, Ra+Rb+Rc, to accordingly change a position of the zero Z1 in the transfer function toward a high frequency direction as shown in FIG. 3. The control signal Sc may have multiple bits to respectively control the switch devices S₁₁, S₁₂ and S₁₃.

As mentioned above, the zero of conventional LDO regulators rarely changes with a load current to cause a transfer function to have multiple transitions at a high frequency zone such that the LDO circuit is unstable in the high frequency zone. Accordingly, the present disclosure further provides an LDO regulator (e.g., FIG. 2) and an operating method of the LDO regulator (e.g., FIG. 5) in which when a load current exceeds a predetermined current value within a predetermined load current range, the zero is moved toward a high frequency direction such that the zero is able to compensate an output pole to stabilize the LDO circuit.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A low dropout (LDO) regulator, comprising:
an error amplifier, having an inverting input terminal, a noninverting input terminal and an output terminal;
a first transistor, coupled between an input voltage and a first node, and a gate of the first transistor being coupled to the output terminal of the error amplifier;
a compensation capacitor; and
a compensation resistor, wherein the compensation resistor and the compensation capacitor are connected in series between the output terminal of the error amplifier and the first node, wherein the compensation resistor is configured to be switched to at least two resistance.

2. The LDO regulator as claimed in claim 1, wherein
the compensation resistor comprises a first compensation resistor and a second compensation resistor connected in series,
the second compensation resistor is smaller than the first compensation resistor, and
the LDO regulator further comprise a switching device configured to bypass the first compensation resistor according to a control signal.

3. The LDO regulator as claimed in claim 2, wherein
the compensation capacitor, the first compensation resistor and the second compensation resistor are configured to determine a first zero,
the compensation capacitor and the second compensation resistor are configured to determine a second zero, and
a second frequency of the second zero is higher than a first frequency of the first zero.

4. The LDO regulator as claimed in claim 2, further comprising a second transistor coupled between the input voltage and the first node, wherein
a gate of the second transistor is coupled to the gate of the first transistor, and
a size of the second transistor is smaller than that of the first transistor by more than times.

5. The LDO regulator as claimed in claim 4, further comprising:
a current source, coupled between a drain of the second transistor and ground; and
a buffer, coupled between the drain of the second transistor and the switching device.

6. The LDO regulator as claimed in claim 5, further comprising:
an output capacitor, coupled between the first node and the ground.

7. The LDO regulator as claimed in claim 6, wherein
the compensation capacitor and the second compensation resistor determine a second zero,
the output capacitor and an equivalent output resistor of the LDO regulator determine an output pole, and
a second frequency of the second zero is equal to a frequency of the output pole.

8. The LDO regulator as claimed in claim 7, wherein
the LDO regulator has a predetermined load current range, and
the buffer is configured to output the control signal upon a load current of the LDO regulator being larger than a predetermined current value within the predetermined load current range.

9. The LDO regulator as claimed in claim 1, further comprising:
a first voltage divider resistor, connected between the first node and a second node; and
a second voltage divider resistor, connected between the second node and ground.

10. The LDO regulator as claimed in claim 9, wherein
the second node is coupled to the noninverting input terminal of the error amplifier, and
the inverting input terminal of the error amplifier is coupled to a reference voltage.

11. An LDO regulator, comprising:
a compensation capacitor;
a first compensation resistor;
a second compensation resistor, wherein the second compensation resistor, the first compensation resistor and the compensation capacitor are connected in series; and
a switching device, configured to bypass the first compensation resistor,
wherein the compensation capacitor, the first compensation resistor and the second compensation resistor are configured to determine a first zero,
the compensation capacitor and the second compensation resistor are configured to determine a second zero, and
the switching device is configured to bypass the first compensation resistor upon a load current of the LDO regulator being larger than a predetermined current value.

12. The LDO regulator as claimed in claim 11, wherein the second compensation resistor is smaller than the first compensation resistor.

13. The LDO regulator as claimed in claim 11, further comprising:
an error amplifier, wherein the compensation capacitor, the first compensation resistor and the second compensation resistor are connected between an output terminal of the error amplifier and a first node; and
an output capacitor, coupled between the first node and ground,
wherein, the output capacitor and an equivalent output resistor of the LDO regulator determine an output pole.

14. The LDO regulator as claimed in claim 13, wherein resistance of the second compensation resistor is selected in the way that when the first compensation resistor is bypassed, a second frequency of the second zero is equal to a frequency of the output pole.

15. The LDO regulator as claimed in claim 11, further comprising:
a transistor;
a current source, coupled to a drain of the transistor; and
a buffer, coupled between the switching device and the drain of the transistor.

16. An operating method of an LDO regulator, the LDO regulator comprising a zero control circuit, a current detection circuit and a buffer coupled between the zero control circuit and the current detection circuit, the operating method comprising:
detecting, by the current detection circuit, a load current of the LDO regulator;
outputting, by the buffer, a control signal upon the detected load current being larger than a predetermined current value; and
moving a frequency of a zero toward a high frequency direction after the zero control circuit receives the control signal.

17. The operating method as claimed in claim 16, wherein
the zero control circuit comprises a compensation capacitor, a first compensation resistor and a second compensation resistor connected in series,
the compensation capacitor, the first compensation resistor and the second compensation resistor determine a first zero,
the compensation capacitor and the second compensation resistor determine a second zero, and
a second frequency of the second zero is higher than a first frequency of the first zero.

18. The operating method as claimed in claim 16, wherein
the LDO regulator has a predetermined load current range, and
the predetermined current value is within the predetermined load current range.

19. The operating method as claimed in claim 16, wherein the current detection circuit comprises:
a transistor; and
a current source, coupled to a drain of the transistor,
wherein the buffer is coupled to the drain of the transistor.

20. The operating method as claimed in claim 16, wherein the buffer is composed of two cascaded inverters.
